(19) United States
(12) Patent Application Publication
(10) Pub. No.: US 2026/0351206 A1
(43) Pub. Date: Nov. 5, 2026

(54) DISPLAY APPARATUS AND DISPLAY METHOD

(71) Applicant: SONY GROUP CORPORATION, TOKYO (JP)

(72) Inventor: HIROAKI KIMURA, TOKYO (JP)

(21) Appl. No.: 19/486,997

(22) PCT Filed: May 16, 2024
(86) PCT No.: PCT/JP2024/018089

§ 371 Date: Nov. 24, 2025

(30) Foreign Application Priority Data
May 30, 2023 (JP) 2023-088738

(51) Int. Cl. G09G 3/34; G02F 1/13357; G02F 1/13363; G02F 1/1343; G02F 1/1347; G02F 1/139; G09G 3/00; G09G 3/36

(52) U.S. Cl. CPC G09G 3/342; G02F 1/13362; G02F 1/13363; G02F 1/134363; G02F 1/13471; G02F 1/1393; G09G 3/003; G09G 3/36; G09G 2320/0209; G09G 2320/0247; G09G 2320/0686

(57) ABSTRACT

A display apparatus includes a backlight; a retarder panel configured to switch a phase of light to pass through the retarder panel between a first phase and a second phase; a base panel provided between the backlight and the retarder panel and configured to transmit light from the backlight in response to an image signal and emit the light to the retarder panel; and a control unit configured to control driving of each of the backlight, the retarder panel, and the base panel. The control unit causes the backlight to emit light during a time period from a time point at which a time period corresponding to a response speed of the base panel has elapsed from a start timing of a frame period based on the image signal to a writing start timing in a next frame period, and switches between the first phase and the second phase of the retarder panel in accordance with a timing at which the backlight starts to emit light.

### TECHNICAL FIELD

The present disclosure relates to a display apparatus and a display method.

### BACKGROUND ART

A three-dimensional (3D) display system is known that enables stereoscopic viewing in a manner that left-eye and right-eye images are displayed on a display device in different phases in a time-division manner and observed using 3D glasses corresponding to the phases of the display device on the left and right sides.

In such a time-division 3D display, the left-eye and right-eye images are switched for each frame and displayed on the display device. By increasing the switching speed of the left-eye and right-eye images, it is possible to reduce flickers.

In the 3D display system using the time-division 3D display, the left-eye and right-eye images are mixed during a frame period, for example, due to sequential scanning of the display device. Further, a predetermined transition time is required for switching frame images due to the response characteristics of the display device. Therefore, when the switching of the images of the left and right eyes is performed at a high speed, the flicker characteristics are improved, but crosstalk might be worsened. PTLs 1 and 2 disclose techniques for reducing such crosstalk.

### CITATION LIST

### Patent Literature

PTL 1: US 2011/074773 A

PTL 2: US 2011/115994 A

### SUMMARY

### Technical Problem

However, it is difficult to achieve sufficient display characteristics with use of the methods disclosed in PTLs 1 and 2. For example, in the medical field, a video having a higher resolution is required, but the methods disclosed in PTLs 1 and 2 have difficulty in enabling securing characteristics that can withstand practical use. Thus, a method for achieving sufficient flicker characteristics and crosstalk characteristics in a 3D display system using time-division 3D display is required.

An object of the present disclosure is to provide a display apparatus and a display method that can achieve sufficient flicker characteristics and crosstalk characteristics in time-division 3D display.

### Solution to Problem

A display apparatus according to the present disclosure includes a backlight; a retarder panel configured to switch a phase of light to pass through the retarder panel between a first phase and a second phase; a base panel provided between the backlight and the retarder panel and configured to transmit light from the backlight in response to an image signal and emit the light to the retarder panel; and a control unit configured to control driving of each of the backlight, the retarder panel, and the base panel, in which the control unit causes the backlight to emit light during a time period from a time point at which a time period corresponding to a response speed of the base panel has elapsed from a start timing of a frame period based on the image signal to a writing start timing in a next frame period, and switches between the first phase and the second phase of the retarder panel in accordance with a timing at which the backlight starts to emit light.

### BRIEF DESCRIPTION OF DRAWINGS

FIG. 1 is a schematic diagram schematically illustrating a configuration of an example of a display system applicable to each embodiment of the present disclosure.

FIG. 2 is a block diagram illustrating a configuration of an example of a display apparatus according to each embodiment.

FIG. 3 is a schematic diagram illustrating a panel module configuration of an example of the display apparatus according to each embodiment.

FIG. 4 is a schematic diagram showing an example of a relationship between a driving state of an active retarder panel and a viewing state in 3D glasses according to each embodiment.

FIG. 5 is a schematic diagram illustrating another example of an active retarder panel according to an embodiment.

FIG. 6 is a block diagram illustrating a hardware configuration of an example of the display apparatus according to an embodiment.

FIG. 7 is a block diagram illustrating a configuration of an example of the display apparatus according to a first embodiment.

FIG. 8 is a schematic diagram illustrating an example of drive timings of a base panel, a backlight, and an active retarder panel when the frame rate is 240 Hz, in the first embodiment.

FIG. 9 is a schematic diagram illustrating an example of the drive timings of the base panel, the backlight, and the active retarder panel when the frame rate is 180 Hz, in the first embodiment.

FIG. 10 is a schematic diagram for explaining 3D crosstalk due to the drive frequency of the base panel, in the first embodiment.

FIG. 11 is a schematic diagram for explaining a driving method according to a second embodiment.

FIG. 12A is a schematic diagram showing an example of a 3D crosstalk result with each gradation in switching between a left-eye image and a right-eye image when overdrive driving is not performed.

FIG. 12B is a schematic diagram showing an example of the 3D crosstalk result with each gradation in switching between the left-eye image and the right-eye image when the overdrive driving is performed.

FIG. 13 is a schematic diagram for explaining a driving method of a base panel and a backlight according to a third embodiment.

FIG. 14 is a block diagram illustrating a configuration of an example of a BL dimming processing unit according to the third embodiment.

FIG. 15 is a schematic diagram for explaining processing in a BL optical correction unit according to the third embodiment.

### DESCRIPTION OF EMBODIMENTS

Hereinafter, embodiments of the present disclosure will be described in detail with reference to the drawings. Note that, in the following embodiments, the same components are denoted by the same reference signs, and redundant description will be omitted.

Hereinafter, the embodiments of the present disclosure will be described in the following order.
1. Overview of Present Disclosure
2. Configuration of Each Embodiment
3. First Embodiment
   3-1. Configuration of First Embodiment
   3-2. Drive Control of First Embodiment
4. Second Embodiment
5. Third Embodiment
   5-1. Overdrive Driving
   5-2. Drive Control of Third Embodiment

### 1. Overview of Present Disclosure

The technique according to the present disclosure relates to a display apparatus that performs time-division three-dimensional (3D) display in which left-eye and right-eye images are switched and displayed for each frame.

A display apparatus applicable to the present disclosure switches a left-eye image and a right-eye image for each frame and displays the images on a base panel, in response to a display signal output from a stereo camera or the like. The base panel is, for example, a liquid crystal panel, and transmits light from a backlight provided on the back side of the base panel, while controlling the transmittance for each pixel in response to the display signal. The light emitted from the base panel is incident on a retarder panel. The retarder panel is an active retarder that switches the phase of the incident light for each frame and emits the light.

A user observes the images on the base panel via the retarder panel. At this time, the user wears 3D glasses that transmit light beams having different phases for the left and right eyes. Then, a left-eye image and a right-eye image are alternately incident on the left and right eyes for each frame, and a stereoscopic image can be observed by the user due to an afterimage effect.

In this way, in the configuration in which the time-division 3D display is performed, the left-eye and right-eye images are switched and displayed for each frame, and thus the following problems occur in known techniques.
(a) Occurrence of crosstalk (referred to as 3D crosstalk) due to mixing of each of the left-eye image and the right-eye image in the other image.
(b) Occurrence of flickering (flickers) due to repeated brightness and darkness in each of the left and right eyes, which is caused by the left-eye image and the right-eye image being switched and displayed.

Among these, the 3D crosstalk described in (a) is mainly caused by the fact that the left-eye image and the right-eye image are mixed in the same frame due to sequential scanning of the base panel, and the fact that the left-eye image and the right-eye image are not immediately switched (there is a transition period) due to liquid crystal response characteristics. That is, since the base panel generally updates the display by sequential scanning in which horizontal lines are sequentially scanned, the left-eye image and the right-eye image are mixed in one frame.

It is also known that flickers in (b) are reduced by increasing the frame rate of the display on the base panel. According to the verification results of the applicant, it is confirmed that when the frame rate of the base panel is equal to or higher than 180 Hz (90 Hz for one eye), flickers are hardly noticeable (ITU-R (ITU Radiocommunication Sector) 4.0 or higher).

On the other hand, the 3D crosstalk described above in (a) and flickers described above in (b) are in a trade-off relationship, and as the frame rate of display is increased, the frame period is shortened, and accordingly, there is a risk that the 3D crosstalk might be worsened due to the base panel or the retarder panel not being able to respond.

Therefore, a display apparatus according to the present disclosure drives the base panel at a frame rate at which flickers are not perceived. Further, the backlight is turned on during a light emission period from a time point at which a time period corresponding to the response speed of the base panel has elapsed from the start timing of one frame period based on the display signal, to the writing start timing in the next one frame period. Furthermore, the phases of the retarder panel are switched in accordance with the timing at which the backlight starts to emit light.

Note that the “writing” here refers to an operation for causing a display device used in the display apparatus to perform display in response to a display signal. For example, when the display apparatus uses a liquid crystal panel as the display device, the “writing” refers to applying a voltage to the liquid crystal.

The display apparatus according to the present disclosure drives the base panel, the backlight, and the retarder panel in accordance with these conditions, and it is thus possible to reduce the 3D crosstalk in the left-eye and right-eye images, and to suppress flickers.

### 2. Configuration of Each Embodiment

Next, a configuration according to each embodiment of the present disclosure will be described.

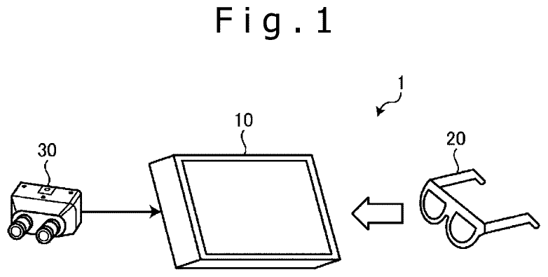

FIG. 1 is a schematic diagram schematically illustrating a configuration of an example of a display system applicable to each embodiment of the present disclosure. In FIG. 1, a display system 1 includes a display apparatus 10 and 3D glasses 20. The display apparatus 10 receives an image signal including respective signals of a left-eye image and a right-eye image output from an imaging device 30, which is, for example, a stereo camera.

The display apparatus 10 includes the backlight, the base panel, and the retarder panel described above, and a control unit for controlling driving of these components. The display apparatus 10 drives the base display panel while switching between the left-eye image and the right-eye image for each frame, based on the image signal input from the imaging device 30. At the same time, the display apparatus 10 controls the lighting timing of the backlight, based on the image signal input from the imaging device 30. Further, the display apparatus 10 drives the retarder panel, based on the image signal so as to cause the phase of the light transmitted through the retarder panel to be different for each frame.

The 3D glasses 20 are formed by providing, for the left and right eyes, polarizing plates having phases respectively corresponding to two phases of the retarder panel. The user can acquire a stereoscopic image based on the left-eye image and the right-eye image output from the imaging device 30 by wearing the 3D glasses 20 and observing a display screen (retarder panel) of the display apparatus 10.

Note that, in the example of FIG. 1, the display screen of the display apparatus 10 is observed by one pair of 3D glasses 20 (one user), but this is for the sake of explanation, and the configuration is not limited to this example. For example, in the display system 1, a plurality of users each wearing the 3D glasses 20 can simultaneously acquire a stereoscopic image displayed on the display screen of the display apparatus 10 within a viewing angle range permissible on the display screen of the display apparatus 10.

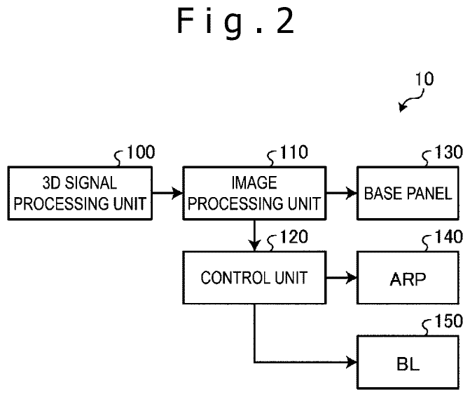

FIG. 2 is a block diagram illustrating a configuration of an example of the display apparatus 10 according to each embodiment. In FIG. 2, the display apparatus 10 includes a 3D signal processing unit 100, an image processing unit 110, a control unit 120, a base panel 130, an active retarder panel 140, and a backlight 150.

Note that, in FIG. 2, the active retarder panel 140 is indicated as an ARP 140. Further, the backlight 150 is indicated as a BL 150. The indications of the ARP 140 and the BL 150 in this drawing will be applied to the following drawings in the same manner.

In FIG. 2, the 3D signal processing unit 100, the image processing unit 110, and the control unit 120 are implemented by hardware circuits that operate in cooperation with each other. No such limitation is intended, and the 3D signal processing unit 100, the image processing unit 110, and the control unit 120 may be implemented by executing a display control program according to each embodiment on a central processing unit (CPU).

The 3D signal processing unit 100 receives, from the imaging device 30, the image signal including the respective signals of the left-eye image and the right-eye image. Hereinafter, the image signal of the left-eye image may be referred to as an image signal L, and the image signal of the right-eye image may be referred to as an image signal R. The 3D signal processing unit 100 performs predetermined image processing such as scaler processing and image quality adjustment processing on each input image signal, and outputs the processed image signal. The image processing unit 110 integrates the image signals L and R output from the 3D signal processing unit 100 to convert the image signals L and R into a frame sequential image signal, and performs predetermined image processing such as frame rate conversion processing.

The image processing unit 110 generates a drive control signal for driving the base panel 130, based on the image signal subjected to the image processing. The image processing unit 110 supplies, to the base panel 130, the image signal subjected to the image processing and the drive control signal generated based on the image signal. The base panel 130 displays the left-eye image and the right-eye image while switching between the left-eye image and the right-eye image for each frame in accordance with the supplied drive control signal and image signal.

The image processing unit 110 supplies the drive control signal also to the control unit 120. The control unit 120 generates a drive control signal for driving the active retarder panel 140, based on the supplied drive control signal, and supplies the generated drive control signal to the active retarder panel 140. The active retarder panel 140 switches, for each frame, between a first phase and a second phase different from the first phase with respect to the light to be transmitted, in accordance with the supplied drive control signal.

Further, the control unit 120 generates a drive control signal for driving the backlight 150 based on the supplied drive control signal for driving the base panel, and supplies the generated drive control signal to the backlight 150. Based on the supplied drive control signal, the backlight 150 is turned on in accordance with the frame period and the response speed of the base panel 130.

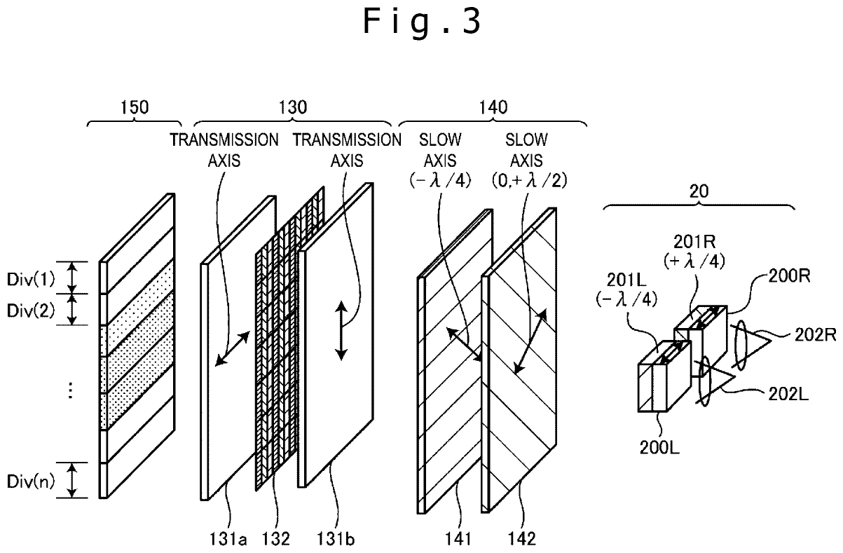

FIG. 3 is a schematic diagram illustrating a panel module configuration of an example of the display apparatus 10 according to each embodiment. As illustrated in FIG. 3, the base panel 130 is disposed between the backlight 150 and the active retarder panel 140.

The base panel 130 is formed as a liquid crystal display (LCD) including a liquid crystal cell 132 and polarizing plates 131a and 131b respectively provided on an incident side and an emission side of the liquid crystal cell 132. The liquid crystal cell 132 is formed by liquid crystal being sealed between two glass plates facing each other with a predetermined gap therebetween, each of the glass plates being provided with a transparent electrode formed on an inward-facing surface thereof. In the embodiment, as the liquid crystal sealed in the liquid crystal cell 132, in-plane-switching (IPS) liquid crystal is used. The IPS liquid crystal has a wider viewing angle than, for example, twisted nematic (TN) liquid crystal, but has a slower response speed than TN liquid crystal.

The liquid crystal cell 132 can control the luminance of transmitted light in accordance with a voltage, for each of pixels arranged in a two-dimensional lattice pattern. In the liquid crystal cell 132, a first direction of the two-dimensional lattice in which the pixels are arranged is defined as a horizontal direction, and a second direction perpendicular to the first direction is defined as a vertical direction. In the liquid crystal cell 132, a line is formed by a row of pixels arranged in a row in the horizontal direction. The liquid crystal cell 132 is controlled to be driven in a line sequential manner in accordance with the drive control signal. That is, the liquid crystal cell 132 is driven (written) at different timings between an upper end line and a lower end line, for example.

The liquid crystal cell 132 controls a voltage applied to the liquid crystal so as to turn the phase of the incident light by, for example, 0° to 90° in accordance with the voltage, and emits the incident light. Therefore, disposing the polarizing plates 131a and 131b having phases different from each other by 90° on the incident side and the emission side of the liquid crystal cell 132 makes it possible to control the luminance of the transmitted light passing through the liquid crystal cell 132. In the example of FIG. 3, the phase of the transmission axis of the polarizing plate 131a on the incident side is the horizontal direction, and the phase of the transmission axis of the polarizing plate 131b on the emission side is the vertical direction. Note that the application of a voltage to liquid crystal may be referred to as writing to the liquid crystal.

It is desirable that the base panel 130 can be driven at a frame period of 180 Hz to 240 Hz and the liquid crystal response speed is 10 ms or less. The liquid crystal response speed refers to an average value of the speeds obtained when changes in the luminance in switching between the black level and the white level are at 10 % and 90 %.

Further, in the liquid crystal cell 132, for example, R (red), G (green), and B (blue) color filters are provided on the emission side.

In FIG. 3, the backlight 150 is disposed on the incident side of the base panel 130. As illustrated in FIG. 3, the backlight 150 according to the embodiment is divided into n regions, namely, Div (1), Div (2), . . . , and Div (n) in the vertical direction, each of which can be independently controlled to emit light. The respective regions Div (1), Div (2), . . . , and Div (n) can be sequentially driven in the vertical direction. Further, each of the regions Div (1), Div (2), and Div (n) may use a light-emitting diode (LED) as a light-emitting element. The backlight 150 is driven to emit light by, for example, a pulse width modulation (PWM) signal, and the light emission luminance can be controlled by controlling the pulse width of the PWM signal.

In FIG. 3, the active retarder panel 140 is disposed on the emission side of the base panel 130. In this example, the active retarder panel 140 includes a retardation film 141 and a liquid crystal cell 142. The retardation film 141 has a phase of −λ/4 on the slow axis. The liquid crystal cell 142 has a phase of +λ/2 on the slow axis when the applied voltage is low (for example, 0 V), and has a phase of 0 on the slow axis when the applied voltage is high (for example, the maximum voltage that can be applied). Therefore, the active retarder panel 140 has a phase of +λ/4 on the slow axis when the voltage applied to the liquid crystal cell 142 is 0 V, and has a phase of −λ/4 on the slow axis when the voltage applied to the liquid crystal cell 142 is at the maximum.

Note that, in FIG. 3, the liquid crystal cell 142 in the active retarder panel 140 forms one region as a whole, but the configuration is not limited to this example. That is, the liquid crystal cell 142 may be divided into a plurality of regions, each of which can be independently controlled to be driven in the vertical direction. Further, as the liquid crystal sealed in the liquid crystal cell 142, liquid crystal having a higher response speed than the liquid crystal used for the base panel 130 is preferably used.

The 3D glasses 20 are formed by providing linear polarizing plates 200L and 200R and retardation plates 201L and 201R, respectively, having phase differences of −λ/4 and +λ/4, at lens portions for a left eye 202L and a right eye 202R, respectively.

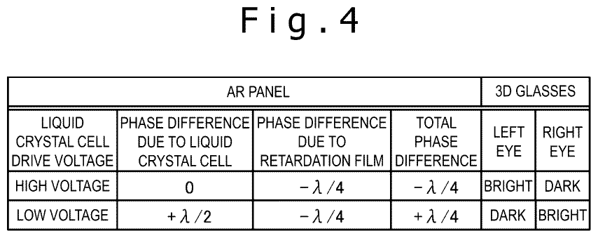

FIG. 4 is a schematic diagram showing an example of a relationship between a driving state of the active retarder panel 140 and a viewing state in the 3D glasses 20 according to each embodiment.

As shown in FIG. 4, in the active retarder panel 140, the phase of the retardation film 141 is fixed at −λ/4. On the other hand, as described above, the phase of the liquid crystal cell 142 is 0 when the applied voltage is high, and is +λ/2 when the applied voltage is low. Therefore, the total phase of the active retarder panel 140 is −λ/4 when the applied voltage to the liquid crystal cell 142 is high, and is +λ/4 when the applied voltage is low. Note that the active retarder panel 140 preferably has, for example, a phase difference of +λ/4 and a response characteristic of approximately 2.0 msec or less.

Consideration is given to a viewing state by the left eye 202L and the right eye 202R obtained when the active retarder panel 140 is viewed through the 3D glasses in which the phases of the transmission axes on the left-eye side and the right-eye side are −λ/4 and +λ/4, respectively. In this case, when the voltage applied to the liquid crystal cell 142 of the active retarder panel 140 is high, the active retarder panel 140 appears bright at the left eye 202L, that is, the display by the base panel 130 is seen through, and the active retarder panel 140 appears dark at the right eye 202R, that is, the display by the base panel 130 is darkened or cannot be seen. On the other hand, when the voltage applied to the liquid crystal cell 142 is low, the active retarder panel 140 appears dark at the left eye 202L and bright at the right eye 202R.

Therefore, the images displayed on the base panel 130 are switched between the left-eye image and the right-eye image for each frame, and the voltage applied to the active retarder panel 140 is controlled in synchronization with the switching, so that the user alternately views the left-eye image and the right-eye image in a frame period. By setting the frame rate to be equal to or higher than a predetermined value, the user can observe a stereoscopic image in which the left-eye image and the right-eye image are synthesized by afterimages of the left-eye image and the right-eye image.

### Another Example of Active Retarder Panel

In the example of FIG. 3, the active retarder panel 140 is formed by combining the retardation film 141 and the liquid crystal cell 142, but the configuration is not limited to this example. That is, the active retarder panel 140 may have another configuration as long as the total phase differences are −λ/4 and +λ/4.

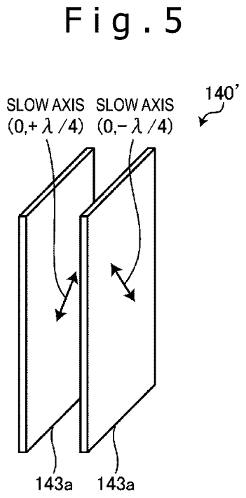

FIG. 5 is a schematic diagram illustrating another example of an active retarder panel according to the embodiment. In FIG. 5, an active retarder panel 140′ is formed by combining two liquid crystal panels 143a and 143b. In the liquid crystal panel 143 a, the phase of the slow axis can be switched between 0 and +λ/4, and in the liquid crystal panel 143b, the phase of the slow axis can be switched between 0 and −λ/4.

### Example of Hardware Configuration of Display Apparatus According to Embodiment

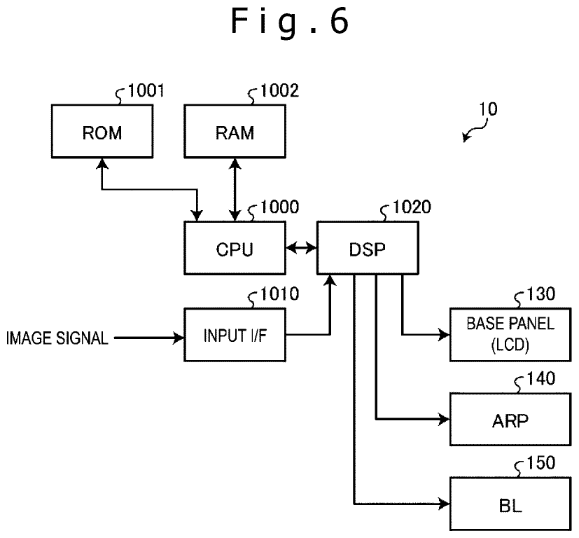

FIG. 6 is a block diagram illustrating a hardware configuration of an example of the display apparatus 10 according to the embodiment.

In FIG. 6, the display apparatus 10 includes a CPU 1000, a read only memory (ROM) 1001, a random access memory (RAM) 1002, an input interface (I/F) 1010, a digital signal processor (DSP) 1020, the base panel 130, the active retarder panel (ARP) 140, and the backlight (BL) 150.

Note that the DSP 1020 may be implemented by being incorporated into a field-programmable gate array (FPGA). Further, some or all of the CPU 1000, the ROM 1001, the RAM 1002, and the input I/F 1010 may be incorporated into the FPGA.

The CPU 1000 controls the entire operation of the display apparatus 10 in accordance with a program stored in the ROM 1001, using the RAM 1002 as a work memory.

The input I/F 1010 receives the image signal including the left-eye image and the right-eye image output from the imaging device 30, for example. The DSP 1020 implements, for example, functions of the 3D signal processing unit 100, the image processing unit 110, and the control unit 120 in FIG. 2, performs predetermined processing on the image signal input to the input I/F 1010 in accordance with the control of the CPU 1000, and generates the image signal to be supplied to the base panel 130 and the drive control signals to be supplied to the base panel 130, the active retarder panel 140, and the backlight 150.

The display apparatus 10 is not limited thereto, and may further include a storage device, a communication I/F, a user input device, and the like.

In a case where the 3D signal processing unit 100, the image processing unit 110, and the control unit 120 described above are implemented by executing a program on the CPU 1000, the CPU 1000 executes the program according to each embodiment in the display apparatus 10, whereby the 3D signal processing unit 100, the image processing unit 110, and the control unit 120 described above are formed, for example, as modules in a main storage area of the RAM 1002.

The program can be acquired from the outside via a communication network, for example, by communication via a communication I/F (not illustrated), and can be installed on the display apparatus 10. The program is not limited thereto, and may be provided by being stored in a detachable storage medium such as a compact disk (CD), a digital versatile disk (DVD), or a universal serial bus (USB) memory. Further, the program may be provided by being stored in the ROM 1001 in advance.

### 3. First Embodiment

Next, the first embodiment of the present disclosure will be described.

### 3-1. Configuration of First Embodiment

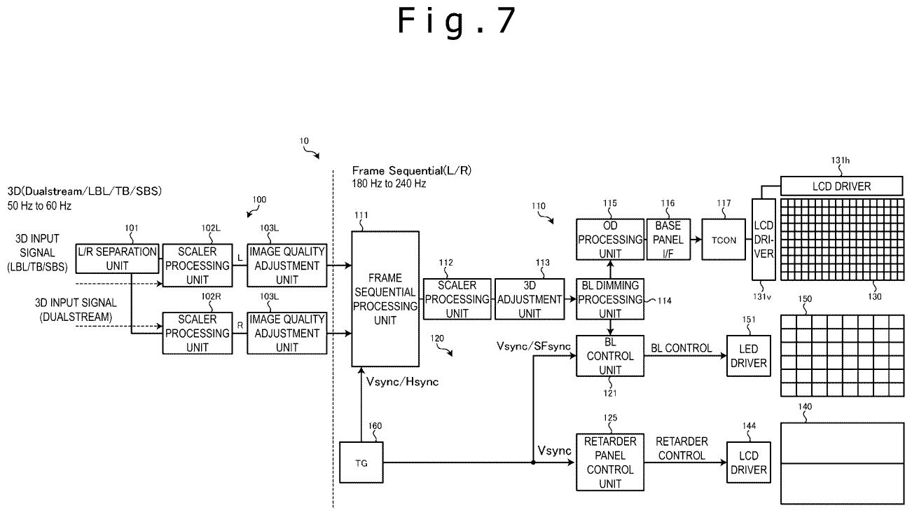

FIG. 7 is a block diagram illustrating a configuration of an example of the display apparatus 10 according to the first embodiment.

In FIG. 7, the display apparatus 10 includes an L/R separation unit 101, a scaler processing unit 102L and an image quality adjustment unit 103L for the left-eye image, and a scaler processing unit 102R and an image quality adjustment unit 103R for the right-eye image, as components corresponding to the 3D signal processing unit 100 described with reference to FIG. 2.

For example, the image signal output from the imaging device 30 is input to the display apparatus 10 (3D signal processing unit 100) as a 3D input signal including the image signal L of the left-eye image and the image signal R of the right-eye image. The 3D input signal, where the image signals L and R are integrated into one stream, may be input using a signaling system such as line-by-line (LBL), top-and-bottom (TB), side-by-side (SBS), or the like. The 3D input signal input to the 3D signal processing unit 100 has a frame rate of, for example, 50 Hz to 60 Hz.

The 3D input signal is input to the L/R separation unit 101, and is separated into the image signal L of the left-eye image and the image signal R of the right-eye image. The image signal L is subjected to predetermined scaler processing and image quality adjustment processing by the scaler processing unit 102L and the image quality adjustment unit 103L, respectively, and is output from the 3D signal processing unit 100. Similarly, the image signal R is subjected to predetermined scaler processing and image quality adjustment processing by the scaler processing unit 102R and the image quality adjustment unit 103R, respectively, and is output from the 3D signal processing unit 100.

Note that the imaging device 30 may output the image signal as a dual stream signal in which the image signal L of the left-eye image and the image signal R of the right-eye image are independent of each other. In this case, the image signals L and R are directly input to the scaler processing units 102L and 102R, respectively.

The image signals L and R output from the 3D signal processing unit 100 are input to the image processing unit 110. In FIG. 7, the image processing unit 110 includes a frame Sequential processing unit 111, a 3D adjustment unit 113, a BL dimming processing unit 114, an OD processing unit 115, a base panel I/F 116, and a TCON 117.

Note that, in FIG. 7, a timing generator (TG) 160 generates a vertical synchronization signal Vsync and a horizontal synchronization signal Hsync for driving the base panel 130, based on a clock signal generated by a clock generator (not illustrated), for example. The TG 160 supplies the generated vertical synchronization signal Vsync and horizontal synchronization signal Hsync to the frame sequential processing unit 111, and to a backlight (BL) control unit 121 and a retarder panel control unit 125, which will be described later.

The image signals L and R input to the image processing unit 110 are supplied to the frame sequential processing unit 111. The frame sequential processing unit 111 integrates the supplied image signals L and R into one frame-sequential image signal, based on the vertical synchronization signal Vsync and the horizontal synchronization signal Hsync supplied from the TG 160, and converts the frame rate of the image signal obtained by the integration into a higher frame rate.

The frame sequential processing unit 111 arranges the image signals L and R in the order of the image signal L of the n-th frame, the image signal R of the n-th frame, the image signal L of the (n+1)-th frame, the image signal R of the (n+1)-th frame . . . , and further arranges the image signals of the respective frames in line order, thereby integrating the supplied image signals L and R into one frame-sequential image signal.

Further, the frame sequential processing unit 111 converts the frame rate of the image signal obtained by the integration into a higher frame rate for suppressing flickers, based on the vertical synchronization signal Vsync and the horizontal synchronization signal Hsync supplied from the TG 160. In the first embodiment, as described above, the frame rate is converted from 50 Hz to 60 Hz of the 3D input signal into 180 Hz to 240 Hz (for example, 180 Hz).

The frame sequential processing unit 111 outputs the image signal obtained by integrating the image signals L and R and converting the frame rate, together with the vertical synchronization signal Vsync and the horizontal synchronization signal Hsync. The image signal and the synchronization signals output from the frame sequential processing unit 111 are subjected to the predetermined scaler processing and 3D adjustment processing by the scaler processing unit 112 and the 3D adjustment unit 113, and are supplied to the backlight (BL) dimming processing unit 114.

The BL dimming processing unit 114 outputs the supplied image signal and synchronization signals to the overdrive (OD) processing unit 115. Further, the BL dimming processing unit 114 generates a dimming signal for controlling the pulse width of the PWM signal for driving the backlight 150, based on the supplied image signal and synchronization signals. The BL dimming processing unit 114 outputs the generated dimming signal to the BL control unit 121 described later.

The OD processing unit 115 generates a drive control signal for performing overdrive driving, based on the supplied image signal and synchronization signals. Details of the overdrive driving will be described later. The OD processing unit 115 supplies the image signal, the drive control signal generated based on the image signal, and the synchronization signals to the timing controller (TCON) 117 via the base panel I/F 116.

The TCON 117 converts the supplied image signal into a pixel signal for each pixel of the liquid crystal cell 132 in the base panel 130. Further, the TCON 117 may perform digital to analog (D/A) conversion processing of converting a digital pixel signal into an analog pixel signal. The TCON 117 supplies, to the base panel 130, the pixel signal, the vertical synchronization signal Vsync, and the horizontal synchronization signal Hsync.

The base panel 130 includes an LCD driver 131v for driving, in the vertical direction, each of the pixels arranged in the two-dimensional lattice pattern on the base panel 130, and an LCD driver 131h for driving each of the pixels in the horizontal direction.

The LCD driver 131v selects a line to be driven in the base panel 130, based on the vertical synchronization signal Vsync supplied from the TCON 117. The LCD driver 131h drives the pixels of the line selected by the LCD driver 131v in the base panel 130, based on the pixel signal and the horizontal synchronization signal Hsync supplied from the TCON 117. In this way, the base panel 130 is scanned in a line sequential manner in accordance with the image signal of one frame, and writing of the pixels is performed for each line.

In FIG. 7, the control unit 120 includes the BL control unit 121 and the retarder panel control unit 125.

The BL control unit 121 generates a BL drive control signal for driving the backlight 150, based on the vertical synchronization signal Vsync and the horizontal synchronization signal Hsync supplied from the TG 160 and the dimming signal supplied from the BL dimming processing unit 114. In the first embodiment, the backlight 150 is divided into the plurality of regions Div (1), Div (2), . . . , and Div (n) in the vertical direction. Therefore, the BL control unit 121 may generate the BL drive control signal for each of the regions Div (1), Div (2), . . . , and Div (n), for example, based on the vertical synchronization signal Vsync and the dimming signal.

Note that, in the example of FIG. 3 described above, the backlight 150 is divided into the regions in the vertical direction, but the configuration is not limited to this example. That is, the backlight 150 may be further divided into regions in the horizontal direction. Further, the backlight 150 may be controlled to be driven on the entire surface at once without being divided into regions.

The BL control unit 121 supplies the generated BL drive control signal to an LED driver 151. The LED driver 151 generates a drive signal for driving each LED of the backlight 150, based on the supplied BL drive control signal, and drives the backlight 150 for each of the regions Div (1), Div (2), . . . , and Div (n) by the generated drive signal.

The retarder panel control unit 125 generates an ARP drive control signal for driving the active retarder panel 140, based on the vertical synchronization signal Vsync supplied from the TG 160. In the example of FIG. 7, the active retarder panel 140 is divided into two regions in the vertical direction. Thus, the retarder panel control unit 125 generates the ARP drive control signal for each of the two regions.

The retarder panel control unit 125 supplies the generated ARP drive control signal to an LCD driver 144. The LCD driver 144 generates a drive signal for driving the active retarder panel, based on the supplied ARP drive control signal, and drives the active retarder panel 140, based on the generated drive signal. When the active retarder panel 140 is divided into a plurality of regions, the active retarder panel 140 is driven for each of the regions obtained by the division.

### 3-2. Drive Control of First Embodiment

Next, the drive control according to the first embodiment will be described in more detail.

The base panel 130 switches between the right-eye image and the left-eye image in accordance with the frame timing, and displays the images. In this case, since the base panel 130 switches between the right-eye image and the left-eye image in a line sequential manner over one frame period, an image in which the right-eye image and the left-eye image are mixed is observed when viewed through the 3D glasses 20.

In order to improve the mixture of the right-eye image and the left-eye image, it is conceivable that a method of performing space division control by dividing each of the backlight 150 and the active retarder panel 140 in the vertical direction is used. With this method, in the base panel 130 that is scanned in the line sequential manner, at the timing when the right-eye image and the left-eye image are switched, light emission of the backlight 150 in the region including the line to be scanned and switching, in the region, between the right-eye image and the left-eye image by the active retarder panel 140 are performed in combination. In this way, it is possible to reduce the 3D crosstalk.

With this method, the 3D crosstalk can be reduced by the line sequential scanning of the base panel 130, but there is a case where a sufficient effect cannot be obtained with respect to the 3D crosstalk due to the liquid crystal response characteristics obtained after flickers due to high-speed driving have been reduced.

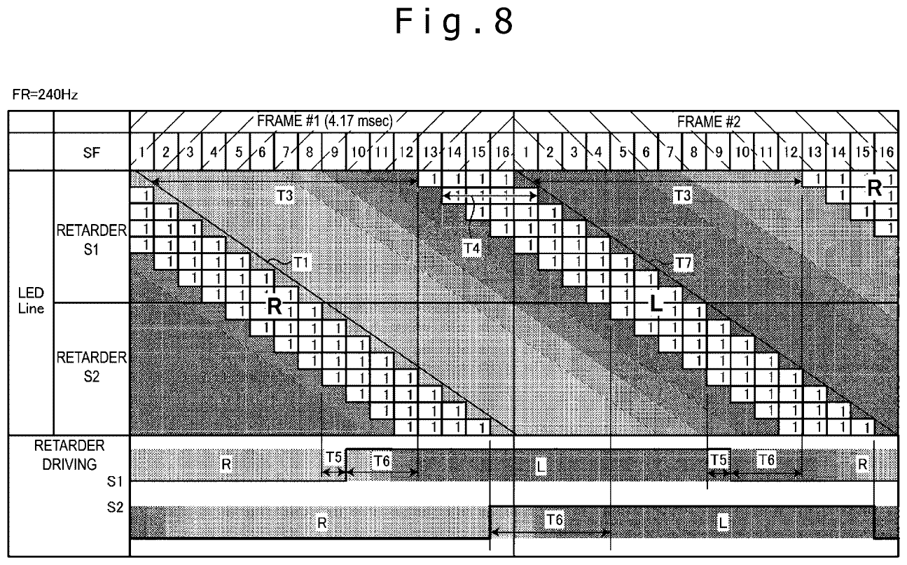

FIG. 8 is a schematic diagram illustrating an example of the drive timings of the base panel 130, the backlight 150, and the active retarder panel 140 when the frame rate is 240 Hz in the first embodiment.

Here, a case where the base panel 130 switches from display of the right-eye image by the image signal R to display of the left-eye image by the image signal L is illustrated as an example. That is, a frame #1 is a frame in which the display by the image signal R is rewritten to the display by the image signal L, and a frame #2 is a frame in which the display by the image signal L is rewritten to the display by the image signal R.

Further, the backlight 150 is divided into 16 regions in the vertical direction, and the backlight 150 is driven in accordance with 16 subframes (SF) obtained by further division of the frame period of 240 Hz. One subframe is 3840 Hz. In the example of FIG. 8, the 16 regions of the backlight 150 obtained by the division are sequentially turned on in a time period T4 equivalent to four subframes. Further, the active retarder panel 140 is driven for every two regions obtained by vertical division into upper and lower regions, and the switching timing is any timing.

In FIG. 8, the horizontal direction indicates the passage of time. Further, the upper part indicates the subframes, and the lower part indicates the drive control of the active retarder panel 140. Note that “S1” refers to the upper region of the active retarder panel 140, and “S2” refers to the lower region thereof.

Further, in FIG. 8, the middle part indicates the drive control of each of the backlight 150 and the base panel 130. In the drawing, each unfilled square marked with “1” indicates that the backlight 150 is turned on, and each filled section indicates the drive control of the base panel 130. The palest filled portion indicates a state based on the image signal L of the left-eye image, and the darkest filled portion indicates a state based on the image signal R of the right-eye image.

In FIG. 8, timings T1 and T7 respectively refer to the display switching timings of the base panel 130, and line sequential scanning is performed over one frame (4.17 ms). For example, at the timing T1, the voltage corresponding to the image signal is applied to the base panel 130 at the beginning of the frame #1, and the orientation of the liquid crystal starts to change. Then, the change in the orientation of the liquid crystal by the application of the voltage is completed at a timing corresponding to the response characteristics of the liquid crystal.

On the other hand, when focusing on the pixels in the uppermost stage obtained by the vertical division into 16 stages corresponding to the division of the backlight 150, the backlight 150 is turned off from the first subframe to the 12th subframe, and emits light during the time period from the 13th subframe to the 16th subframe.

This is because the backlight 150 is turned on after a time period T3 in which the liquid crystal responds and which is an update period of the base panel 130, so as to reduce the 3D crosstalk in which the left-eye image and the right-eye image are mixed. Although the lighting period of the backlight 150 is shortened, the backlight 150 is caused to emit light more brightly in this period, and thus a decrease in the luminance can be prevented. In this example, since the lighting period of the backlight 150 is ¼ of the frame period, the backlight 150 is turned on with a brightness four times the average luminance.

Here, with respect to the 3D crosstalk, the point is the response time of the liquid crystal in response to the switching of the base panel 130 and the active retarder panel 140, which is indicated by time periods T3, T5, and T6. The time period T3 is an allowable time for switching of the liquid crystal in the liquid crystal cell 132 of the base panel 130, and is approximately 3.1 msec. Further, the time periods T5 and T6 are allowable times for switching when the active retarder panel 140 is divided into the two upper and lower regions, and are approximately 1.2 msec.

In this example, the active retarder panel 140 is divided into two regions in the vertical direction, and if the switching timing of the active retarder panel 140 is matched with the switching timing of the backlight 150 (the rear end of the eighth subframe in the example of the drawing), light emission in the region S2 of the backlight 150 leaks into the region S1, and there is thus a risk that the 3D crosstalk may be worsened. Therefore, the switching timing of the active retarder panel 140 is delayed by, for example, one subframe with respect to the switching timing of the backlight 150, as indicated by the time period T5 in the drawing. This time period T5 and the time period T6 required for switching the active retarder panel 140 are provided as a margin for switching the active retarder panel 140, thereby suppressing leakage of the light emitted from the backlight 150.

The response speed of an actual liquid crystal panel is approximately 5 msec to 10 msec for IPS liquid crystal having an excellent viewing angle, and approximately 2 msec for TN liquid crystal having excellent response characteristics but being inferior to IPS liquid crystal in terms of the viewing angle.

The time periods T5 and T6 can be improved by increasing the number of regions obtained by division of the active retarder panel 140 in the vertical direction. On the other hand, the time period T3 depends on the frame rate, and thus depending on the frame rate, even with this driving method, the switching is not performed in time and the 3D crosstalk may be worsened.

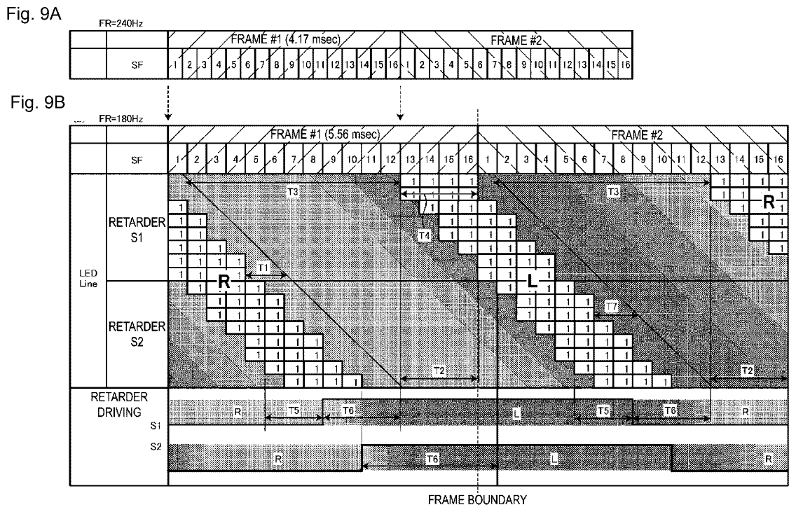

FIG. 9 is a schematic diagram illustrating an example of the drive timings of the base panel 130, the backlight 150, and the active retarder panel 140 when the frame rate is 180 Hz in the first embodiment. FIG. 9 illustrates an example in which the drive timings are determined in accordance with the response characteristics of the base panel 130 and the active retarder panel 140.

In FIG. 9, a section (a) illustrates the frame period and the subframes when the frame rate is 240 Hz, as illustrated in FIG. 8, for comparing them with the frame period and the subframes when the frame rate is 180 Hz.

In the example of FIG. 9, and a blanking period T2 is set with the time period T3, which is the update period (active period) of the base panel 130, set to be equal to one frame period when the frame rate is 240 Hz. The blanking period T2 is a time period added to the update period (time period T3) of the base panel 130, and the frame rate is set to 180 Hz after the addition of the blanking period T2. In the blanking period T2, the voltage applied to the liquid crystal in the base panel 130 is held, and the state of the liquid crystal is held.

Accordingly, the allowable time of the time period T3 is extended from 3.1 msec when the frame rate is 240 Hz as illustrated in FIG. 8, to 4.3 msec. Further, the allowable times of the time periods T5 and T6 are extended from 1.2 msec when the frame rate is 240 Hz as illustrated in FIG. 8, to 2.4 msec.

The number of regions obtained by division of the active retarder panel 140 and the light emission period of the backlight 150 can be adjusted by using these extended periods, and it is thus possible to reduce the 3D crosstalk caused by the response characteristics of the liquid crystal in the base panel 130. According to the verification results of the applicant, it is confirmed that the 3D crosstalk is reduced by 50 % in the same device when it is driven at a frame rate of 180 Hz, compared with when it is driven at a frame rate of 240 Hz.

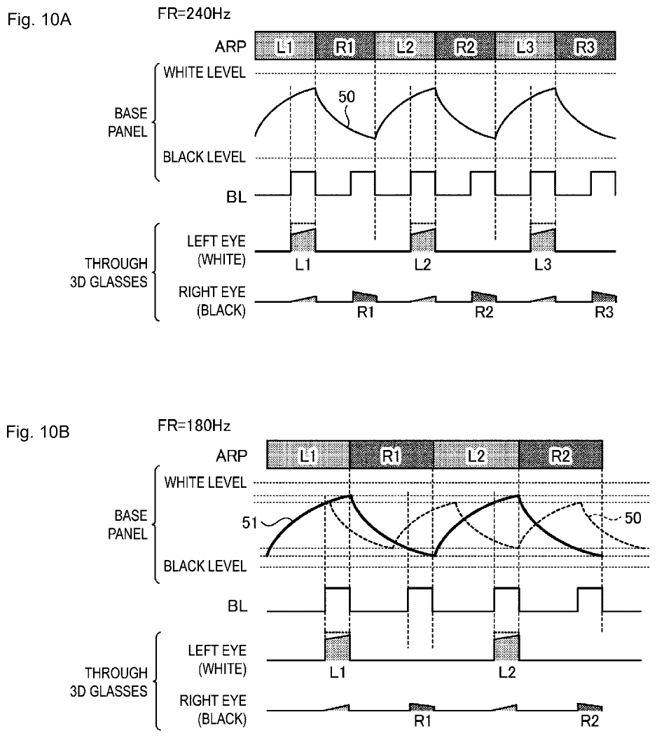

FIG. 10 is a schematic diagram for explaining the 3D crosstalk based on the drive frequency of the base panel 130 according to the first embodiment.

In FIG. 10, the section (a) illustrates an example of the case where the frame rate is 240 Hz described with reference to FIG. 8, and the section (b) illustrates an example of the case where the frame rate is 180 Hz described with reference to FIG. 9. Further, in the sections (a) and (b), the switching timings of the active retarder panel 140, the luminance changes in the base panel 130, the light-emitting states of the backlight 150, and the luminances with respect to the left and right eyes in observation through the 3D glasses 20 are illustrated in this order from the top. The switching timings of the active retarder panel 140 are synchronized with the frame periods. Further, in this example, it is assumed that a white level image signal L is used as the left-eye image, and a black level image signal R is used as the right-eye image.

In the section (a) of FIG. 10, as indicated by a characteristic line 50, the luminance of the base panel 130 changes from the black level to the white level in the time period of the left-eye image, due to the switching from the image signal L to the image signal R. Further, the luminance changes from the white level to the black level in the time period of the right-eye image, due to the switching from the image signal R to the image signal L. When the frame rate is 240 Hz, the base panel 130 switches from the image signal L to the image signal R in a state where the luminance has not completely reached the white level. Similarly, switching from the image signal R to the image signal L occurs in a state where the luminance has not completely reached the black level.

The backlight 150 emits light during a predetermined time period at the rear end of each frame period. As illustrated by the filled portions in the drawing, the display on the left-eye side does not become completely white (L1) during the light emission period of the left-eye image, and the display on the right-eye side does not become completely black (R1) during the light emission period of the right-eye image, through the 3D glasses 20. Further, for example, in the light emission period of the left-eye image, display is performed with the light emitted from the backlight 150 leaking into the right-eye side. The ratio of the luminance (integrated value) on the right-eye side during the light emission period of the left-eye image to the luminance (integrated value) on the left-eye side during the same period is the crosstalk.

When the frame rate is 180 Hz, the frame period is longer than that when the frame rate is 240 Hz. Thus, as illustrated by a characteristic line 51 in the section (b) of FIG. 10 in comparison with the characteristic line 50 obtained when the frame rate is 240 Hz, the characteristics are improved on both the white level side and the black level side. Therefore, even through the 3D glasses 20, for example, leakage of the light emitted from the backlight 150 on the right-eye side is reduced, and the crosstalk is reduced.

As described above, in the first embodiment, the backlight 150 is caused to emit light during a period from a time point at which a time period corresponding to the response speed of the base panel 130 has elapsed from the start timing of one frame period, to the writing start timing in the next one frame period, and the phase of the active retarder panel 140 is switched in accordance with the timing at which the backlight 150 starts to emit light. Therefore, it is possible to reduce the 3D crosstalk, and suppress flickers by increasing the frame rate.

### 4. Second Embodiment

Next, the second embodiment of the present disclosure will be described. The second embodiment is an example in which the blanking period according to the drive frequency is set to be longer than that in the first embodiment described above.

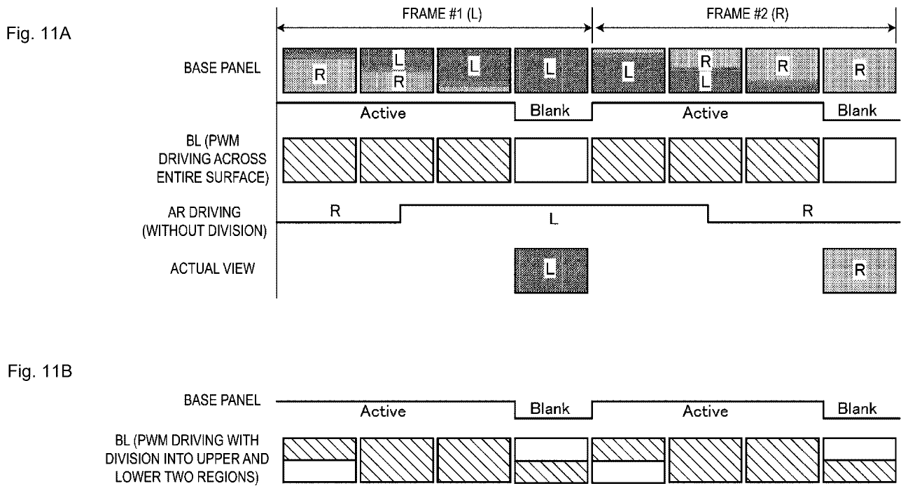

FIG. 11 is a schematic diagram for explaining a driving method according to the second embodiment. In FIG. 11, the active retarder panel 140 is indicated as AR. The section (a) of FIG. 11 illustrates an example of a case where the backlight 150 and the active retarder panel 140 are not divided in the vertical direction, and the section (b) illustrates an example of a case where the backlight 150 is divided into two regions in the vertical direction.

Note that it is assumed that, in the sections (a) and (b), the base panel 130 and the active retarder panel 140 are driven in the same manner, and the frame rate is 180 Hz. Further, an active period is a time period in which a voltage is applied to the liquid crystal in the base panel 130, and a blanking (blank) period corresponds to the above-described blanking period T2 and is a time period in which the voltage applied to the liquid crystal is held.

In the section (a) of FIG. 11, the backlight 150 is caused to emit light from the entire surface thereof in correspondence with the blanking period. The blanking period is set based on the response characteristics of the liquid crystal, but here, the length of the blanking period is set to be a length that allows a predetermined luminance to be secured by the light emission from the backlight 150. Only during the blanking period, an image based on the image signal is visible. Therefore, for the actual view through the 3D glasses 20, the left-eye image is observed on the left-eye side of the 3D glasses 20 during the blanking period in the frame #1 based on the image signal L of the left-eye image, and the right-eye image is observed on the right-eye side of the 3D glasses 20 during the blanking period in the frame #2 based on the image signal R of the right-eye image.

The configuration is not limited to the above-described example, and, for example, the light emission period of the backlight 150 may be delayed, or the backlight 150 may be divided into two regions in the vertical direction and light emission driving may be performed independently in each of the regions obtained by the division.

The section (b) of FIG. 11 illustrates an example in which the backlight 150 is divided into two regions in the vertical direction. In the example of the section (b), the upper region of the backlight 150 divided into two regions is caused to emit light during the blanking period of the frame #1, and the lower region is caused to emit light for the same length of time as that of the blanking period from the beginning of the next frame #2. This enables a higher frame rate, and also implementation according to the response characteristics of the base panel 130.

As described above, in the second embodiment, it is possible to suppress the 3D crosstalk with a simple and low-cost configuration.

### 5. Third Embodiment

Next, the third embodiment of the present disclosure will be described. The third embodiment relates to overdrive driving in driving of the liquid crystal in the base panel 130.

### 5-1. Overdrive Driving

As a method for improving the response characteristics of liquid crystal, overdrive driving is known. In overdrive driving, when switching is performed from a low gradation to a high gradation, the drive voltage for driving the liquid crystal is corrected to a drive voltage for an even higher gradation, and when the drive voltage is switched from a high gradation to a low gradation, the drive voltage is corrected to a voltage for an even lower gradation. By employing overdrive driving for driving the liquid crystal, the response time can be shortened.

In the second embodiment, the response characteristics are improved by correcting the drive voltage for driving the liquid crystal of the base panel 130 to an appropriate drive voltage, based on the gradation difference from the previous frame with respect to the switching between the left-eye image and the right-eye image, that is, the gradation difference between the left-eye image and the right-eye image.

In overdrive driving, the correction is performed within the range of the drive voltage of the liquid crystal cell, and thus, it is highly effective when the achieved gradation is an intermediate gradation. On the other hand, when the achieved gradation is near a high gradation or near a low gradation, a sufficient drive voltage cannot be applied, and the effect of improving the response characteristics is small.

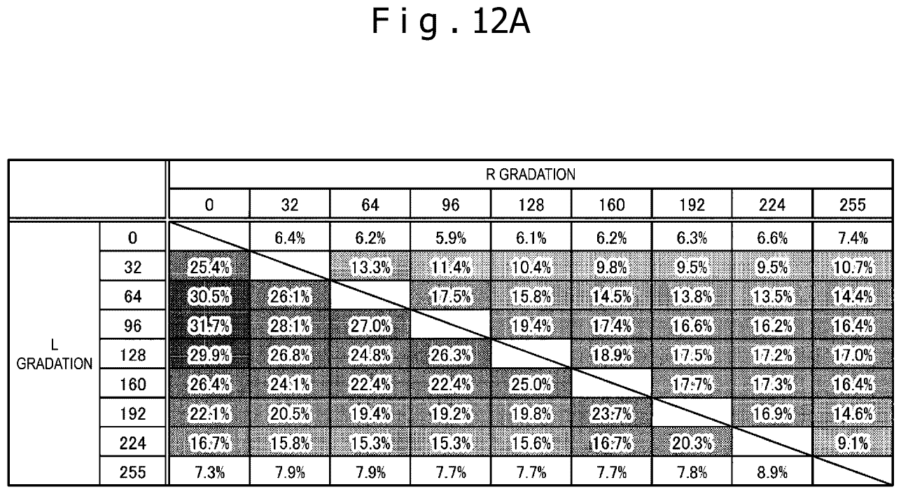

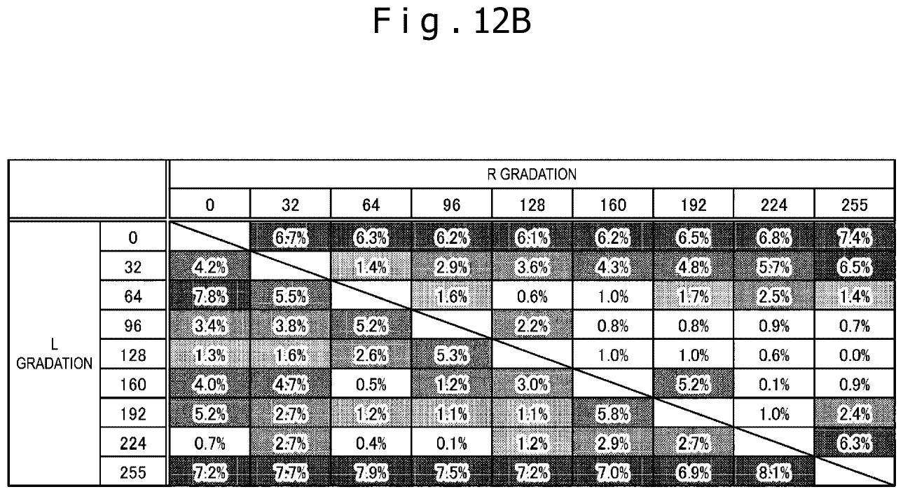

FIG. 12A is a schematic diagram showing an example of a 3D crosstalk result at each gradation in switching between the left-eye image and the right-eye image when overdrive driving is not performed. In FIG. 12A and FIG. 12B described later, L gradations and R gradations indicate the gradations of the left-eye image and the right-eye image, respectively, and the gradation “0” is the lowest gradation and the gradation “255” is the highest gradation. Further, in the examples of FIGS. 12A and 12B, IPS liquid crystal is used for the liquid crystal panel.

The 3D crosstalk depends on the response characteristics of the liquid crystal panel, and since the IPS liquid crystal is used for the liquid crystal panel in this example, the response is fast and the 3D crosstalk is low in switching between low gradation and high gradation (for example, switching between gradation “0” and gradation “255”, namely, so-called white and black). On the other hand, since the gradation transition between intermediate gradations is slow, the 3D crosstalk is also high.

FIG. 12B is a schematic diagram showing an example of a 3D crosstalk result at each gradation in switching between the left-eye image and the right-eye image when overdrive driving is performed. In the example of FIG. 12B, it is understood that the response of intermediate gradations, which is an issue with the IPS liquid crystal, is improved by overdrive driving, and the 3D crosstalk is reduced as compared with the example of FIG. 12A. However, it is understood that, since the effect of the overdrive driving is small with respect to the response in the low gradation region and the high gradation region near the gradation “0” and the gradation “255”, the result of the 3D crosstalk is hardly changed from that of FIG. 12A in which overdrive driving is not performed.

Therefore, the response characteristics can be improved by limiting the use of the high gradation region and the low gradation region and performing the driving at intermediate gradations as effective gradation regions in the base panel 130.

### 5-2. Drive Control of Third Embodiment

In a third embodiment, the gradation range used in the base panel 130 is limited, and the display gradation in the gradation range limited in the base panel 130 is compensated for by the gradation of the backlight 150. By applying the third embodiment, the base panel 130 can be used in the effective gradation region by the above-described overdrive driving.

Note that, in the third embodiment, it is preferable to use an LED that responds at a sufficiently high speed as the backlight 150 and is divided into smaller areas and can be dimmed for each area.

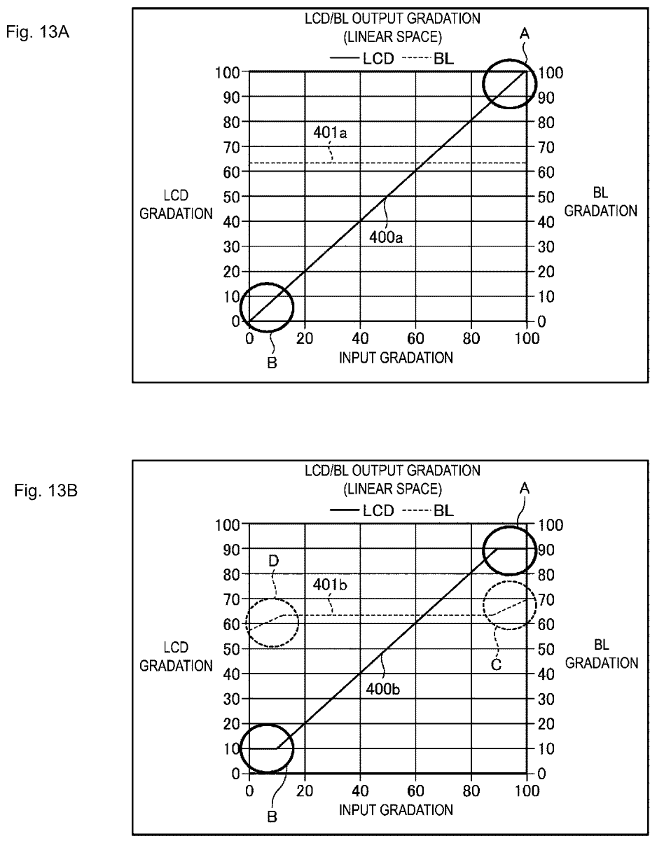

FIG. 13 is a schematic diagram for explaining a driving method of the base panel 130 and the backlight 150 according to the third embodiment.

In FIG. 13, the section (a) illustrates an example of the characteristics of the base panel 130 when the third embodiment is not applied, and the section (b) illustrates an example of the characteristics of the base panel 130 when the third embodiment is applied. In the sections (a) and (b), the horizontal axis represents the gradation of the input signal (input gradation), the vertical axis on the left side represents the gradation of the output signal (output gradation) for the base panel 130, and the vertical axis on the right side represents the output gradation for the backlight 150. Each gradation is normalized to a range of gradation “0” to “100”.

In the section (a) of FIG. 13, the output gradation of the base panel 130 has a characteristic of changing at a constant rate in accordance with the gradation of the input signal, as indicated by a characteristic line 400a. Further, the output gradation of the backlight 150 is constant regardless of the input gradation, as indicated by a characteristic line 401a.

In the third embodiment, as illustrated in the section (b) of FIG. 13, the output gradation of the base panel 130 is limited in the high gradation section and the low gradation side of the input signal, as indicated by ranges A and B of a characteristic line 400b. On the other hand, the output gradation of the backlight 150 is changed so as to compensate for the output gradation of the base panel 130 within the ranges of the input gradation limited in the base panel 130, as indicated by ranges C and D of a characteristic line 401b.

More specifically, for example, in the range C of the characteristic line 401b, the output gradation of the backlight 150 with respect to the input gradation is increased so as to compensate for the limitation on the output gradation in the range A of the input gradation of the base panel 130. Similarly, in the range D of the characteristic line 401b, the output gradation of the backlight 150 with respect to the input gradation is lowered so as to compensate for the limitation on the input gradation of the base panel 130 with respect to the output gradation in the range B.

As described above, in the third embodiment, the output gradation with respect to the input gradation is limited in the low gradation region and the high gradation region of the base panel 130. At the same time, the output gradation of the backlight 150 in these gradation regions is increased or decreased so as to compensate for the limitation of the output gradation of the base panel 130. In this way, it is possible to use the base panel 130 in the effective gradation range by the above-described overdrive driving and to reduce the 3D crosstalk.

The control of the output gradation of the base panel 130 and the backlight 150 according to the third embodiment described above may be performed by, for example, the BL dimming processing unit 114 in FIG. 7.

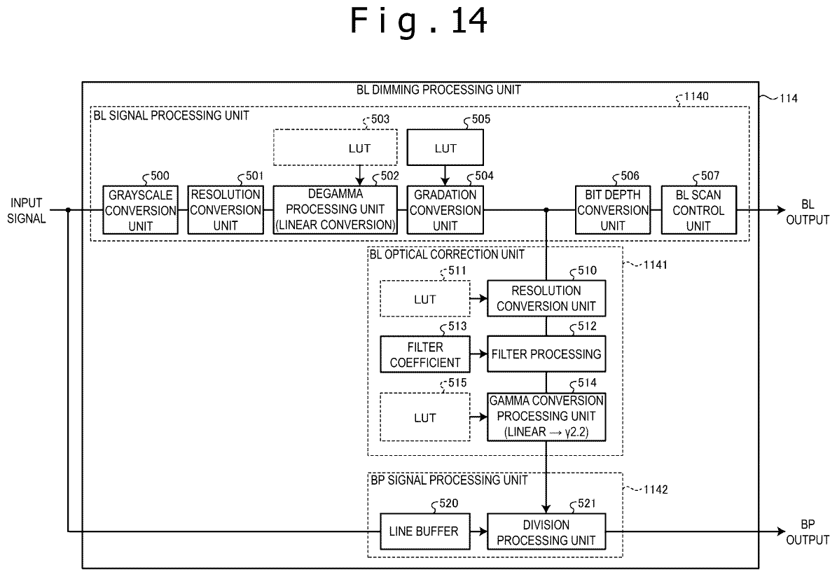

FIG. 14 is a block diagram illustrating a configuration of an example of the BL dimming processing unit 114 according to the third embodiment.

Note that it is assumed that, in this example, the backlight 150 includes 384 regions obtained by dividing the backlight into 24 regions in the horizontal direction and 16 regions in the vertical direction, and the bit depth of the output gradation is 8 bits. It is also assumed that the input signal includes, for example, horizontal 2560 pixels×vertical 1440 pixels and has a bit depth of 10 bits, and similarly, the base panel 130 includes horizontal 2560 pixels×vertical 1440 pixels and a bit depth of 10 bits for the output gradation.

In FIG. 14, the BL dimming processing unit 114 includes a BL signal processing unit 1140, a BL optical correction unit 1141, and a base panel (BP) signal processing unit 1142. The image signal output from the 3D adjustment unit 113 illustrated in FIG. 7 is supplied, as the input signal, to the BL dimming processing unit 114 and input to the BL signal processing unit 1140 and the BP signal processing unit 1142.

The BL signal processing unit 1140 includes a grayscale conversion unit 500, a resolution conversion unit 501, a degamma processing unit 502, a gradation conversion unit 504, a bit depth conversion unit 506, and a BL scan control unit 507.

The grayscale conversion unit 500 detects the maximum value of each of the RGB values of the input signal, and converts the gradation of the input signal into a grayscale, based on the detected maximum value. The resolution conversion unit 501 converts the resolution (2560 pixels×1440 pixels) of the signal output from the grayscale conversion unit 500 into the resolution (24 pixels×16 pixels) of the backlight 150. The degamma processing unit 502 performs degamma processing on the signal output from the resolution conversion unit 501 with reference to a look-up table (LUT) 503, and converts the bit depth from 10 bits into 16 bits by linear conversion.

Here, a LUT 505 is stored in association with the gradation of the input signal and the output gradation of the backlight 150, which are indicated by the characteristic line 401b in the section (b) of FIG. 13. The gradation conversion unit 504 converts the gradations of the high gradation portion and the low gradation portion of the input signal, which has been output from the degamma processing unit 502, with reference to the LUT 505, as illustrated in the ranges C and D of the section (b) of FIG. 13.

The output of the gradation conversion unit 504 is supplied to the bit depth conversion unit 506 and the BL optical correction unit 1141.

The bit depth conversion unit 506 converts the bit depth of the signal supplied from the gradation conversion unit 504 into a bit depth that can be implemented by the backlight 150 (8 bits in this example). The output of the bit depth conversion unit 506 is supplied to the BL scan control unit 507. The BL scan control unit 507 generates signals for the respective regions obtained by dividing the backlight 150 into 24 regions in the horizontal direction and 16 regions in the vertical direction, based on the output of the bit depth conversion unit 506. More specifically, the BL scan control unit 507 performs, for each of the regions, area dimming processing for controlling the pulse width of the PWM signal, based on the output of the bit depth conversion unit 506, and generates the signal for each of the regions. The BL scan control unit 507 outputs the generated signals for the respective regions as BL outputs, in the scan order of the respective regions of the backlight 150.

The BL optical correction unit 1141 includes a resolution conversion unit 510, a filter processing unit 512, and a gamma conversion processing unit 514.

The output of the gradation conversion unit 504 is supplied to the BL optical correction unit 1141 and input to the resolution conversion unit 510. The resolution conversion unit 510 converts, with reference to a LUT 511, the resolution of the input signal from 24 regions×16 regions into 2560 pixels×1440 pixels, which is the resolution of the base panel 130. That is, the resolution conversion unit 510 generates the pixel value of each pixel of the base panel 130, based on the signal for each of the regions obtained by the division of the backlight 150.

The output of the resolution conversion unit 510 is input to the filter processing unit 512. The filter processing unit 512 performs predetermined filter processing on the output of the resolution conversion unit 510, based on a filter coefficient 513 prepared in advance. The filter processing here may include, for example, low-pass filter processing.

The output of the filter processing unit 512 is input to the gamma conversion processing unit 514. The gamma conversion processing unit 514 performs gamma conversion processing on the input signal with reference to a LUT 515. For example, the gamma conversion processing unit 514 performs gamma conversion processing with γ=2.2, for example, on the signal input with linear characteristics.

The output of the gamma conversion processing unit 514 is supplied to the BP signal processing unit 1142. The BP signal processing unit 1142 includes a line buffer 520 and a division processing unit 521.

The input signal supplied to the BP signal processing unit 1142 is stored in the line buffer 520 in units of lines. The division processing unit 521 reads the input signal from the line buffer 520, in units of lines. Further, the output of the resolution conversion unit 510 is input to the division processing unit 521. The division processing unit 521 divides the pixel value of each pixel of the line read from the line buffer 520 by the pixel value of each pixel of the corresponding line input from the resolution conversion unit 510. In this way, the characteristics of the input signal are converted into the characteristics illustrated in the ranges A and B of the characteristic line 400b of the section (b) of FIG. 13.

The division processing unit 521 outputs a signal obtained by converting the characteristics of the input signal, based on the output of the resolution conversion unit 510, as a BP output for driving the base panel 130.

The base panel 130 driven by the BP output whose pixel value has been converted in accordance with the area dimming processing is superimposed on the backlight 150 whose light emission is controlled for each of the regions obtained by the division, in accordance with the BL output output from the BL scan control unit 507 and subjected to the area dimming processing. In this way, the signal obtained by performing division on the original input signal in the division processing unit 521 can be returned to the original input signal in principle.

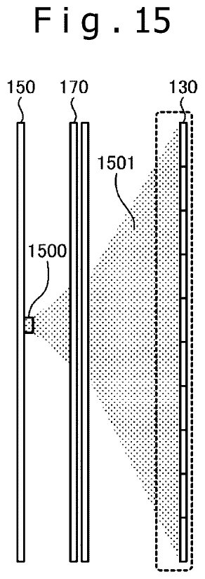

FIG. 15 is a schematic diagram for explaining processing in the BL optical correction unit 1141 according to the third embodiment.

In FIG. 15, light emitted from an LED 1500 of the backlight 150 is diffused by, for example, an optical sheet 170 and the base panel 130 is irradiated with the light. The BL optical correction unit 1141 performs correction processing of the light amount of light 1501 with which the back surface of each pixel of the base panel 130 is irradiated after the light 1501 exits the optical sheet 170.

Note that FIG. 15 illustrates one of the regions obtained by the division of the backlight 150. That is, a plurality of pixels of the base panel 130 are irradiated with the light on one of the regions obtained by the division of the backlight 150.

Here, the characteristics of the light 1501 that enters the back surface of each pixel of the base panel 130, which is surrounded by a dotted line in FIG. 15, are obtained in advance by simulation or the like. For example, the division processing unit 521 illustrated in FIG. 14 may generate the BP output by applying, to the division, a correction coefficient based on the acquired characteristics of the light 1501.

As described above, in the third embodiment, the drive control of the backlight 150 and the base panel 130 by each of the signal processings in FIG. 14 is combined with the overdrive driving. Accordingly, by applying the third embodiment, it is possible to reduce the 3D crosstalk between the gradations in the switching of all the left-eye images and the right-eye images.

Note that the effects described in the present specification are merely examples and are not limited, and other effects may be achieved.

Note that the present technique can also have the following configurations.

(1)

A display apparatus includes a backlight; a retarder panel configured to switch a phase of light to pass through the retarder panel between a first phase and a second phase; a base panel provided between the backlight and the retarder panel and configured to transmit light from the backlight in response to an image signal and emit the light to the retarder panel; and a control unit configured to control driving of each of the backlight, the retarder panel, and the base panel, in which the control unit causes the backlight to emit light during a time period from a time point at which a time period corresponding to a response speed of the base panel has elapsed from a start timing of a frame period based on the image signal to a writing start timing in a next frame period, and switches between the first phase and the second phase of the retarder panel in accordance with a timing at which the backlight starts to emit light.

(2)

In the display apparatus according to (1) described above, the control unit controls the driving of the base panel in accordance with the frame period including a blanking period at a front end or a rear end of the frame period, and causes the backlight to emit light during the blanking period.

(3)

In the display apparatus according to (2) described above, a first region and a second region of the backlight are each driven, the first region and the second region having been obtained by dividing the backlight in a vertical direction, and the control unit causes the first region to emit light during the blanking period, and causes the second region to emit light during a predetermined period immediately after the blanking period.

(4)

In the display apparatus according to any one of (1) to (3) described above, the backlight is divided into a first number of regions in a direction perpendicular to a direction of a line of the base panel, and the control unit drives the base panel in a line sequential manner, and causes the backlight to sequentially emit light from each of the first number of regions in accordance with the driving in the line sequential manner.

(5)

In the display apparatus according to (4) described above, the retarder panel is divided into a second number of regions in the direction perpendicular to the direction of the line of the base panel, and the control unit switches between the first phase and the second phase of each of the second number of regions of the retarder panel obtained by dividing the retarder panel, in accordance with light emission of the first number of regions of the backlight.

(6)

In the display apparatus according to any one of (1) to (5) described above, the control unit causes the backlight to emit light at a timing corresponding to a subframe obtained by dividing the frame period.

(7)

In the display apparatus according to any one of (1) to (6) described above, the frame period is shorter than a time period in which a state of one line in the base panel is updated.

(8)

In the display apparatus according to any one of (1) to (6) described above, the control unit causes the base panel to perform overdrive driving.

(9)

In the display apparatus according to (8) described above, the control unit controls gradation of the backlight with respect to the image signal such that the gradation is high in a predetermined range on a high gradation side and low in a predetermined range on a low gradation side, and limits gradation, in the base panel, of the predetermined range on the high gradation side and of the predetermined range on the low gradation side in accordance with the gradation of the backlight with respect to the image signal.

(10)

In the display apparatus according to (9) described above, the backlight is divided into a plurality of regions in a direction of a line of the base panel and in a direction perpendicular to the direction of the line, and the control unit controls gradation of each of the plurality of regions of the backlight such that the gradation is high in the predetermined range on the high gradation side and low in the predetermined range on the low gradation side, based on the image signal.

(11)

In the display apparatus according to any one of (1) to (10) described above, the base panel is a liquid crystal panel using in-plane-switching (IPS) liquid crystal.

(12)

In the display apparatus according to (11) described above, the retarder panel includes a liquid crystal panel using liquid crystal having a higher response speed than liquid crystal used for the base panel.

(13)

The display apparatus according to (12) described above, the retarder panel includes a combination of a retardation film and the liquid crystal panel.

(14)

In the display apparatus according to (12) described above, the retarder panel includes a combination of two liquid crystal panels each being the liquid crystal panel.

(15)

In the display apparatus according to any one of (1) to (14) described above, the backlight uses a light-emitting diode (LED) as a light source.

(16)

A display method is executed by a processor, and the display method includes controlling driving of each of a backlight, a retarder panel configured to switch a phase of light to pass through the retarder panel between a first phase and a second phase, and a base panel provided between the backlight and the retarder panel and configured to transmit light from the backlight in response to an image signal and emit the light to the retarder panel, in which the controlling includes causing the backlight to emit light during a time period from a time point at which a time period corresponding to a response speed of the base panel has elapsed from a start timing of a frame period based on the image signal to a writing start timing in a next frame period, and switching between the first phase and the second phase of the retarder panel in accordance with a timing at which the backlight starts to emit light.

### REFERENCE SIGNS LIST

1 Display system
10 Display apparatus
20 3D glasses
30 Imaging device
100 3D signal processing unit
101 L/R separation unit
102L, 102R, 112 Scaler processing unit
103L, 103R Image quality adjustment unit
110 Image processing unit
111 Frame sequential processing unit
113 3D adjustment unit
114 BL dimming processing unit
115 OD processing unit
120 Control unit
121 BL control unit
125 Retarder panel control unit
130 Base panel
140 Active retarder panel
150 Backlight
160 TG
170 Optical sheet
500 Grayscale conversion unit
501, 510 Resolution conversion unit
502 Degamma processing unit
503, 505, 511, 515 LUT
504 Gradation conversion unit
506 Bit depth conversion unit
507 BL scan control unit
512 Filter processing unit
514 Gamma conversion processing unit
1140 BL signal processing unit
1141 BL optical correction unit
1142 BP signal processing unit

1. A display apparatus comprising:
a backlight;
a retarder panel configured to switch a phase of light to pass through the retarder panel between a first phase and a second phase;
a base panel provided between the backlight and the retarder panel and configured to transmit light from the backlight in response to an image signal and emit the light to the retarder panel; and
a control unit configured to control driving of each of the backlight, the retarder panel, and the base panel, wherein
the control unit
causes the backlight to emit light during a time period from a time point at which a time period corresponding to a response speed of the base panel has elapsed from a start timing of a frame period based on the image signal to a writing start timing in a next frame period, and
switches between the first phase and the second phase of the retarder panel in accordance with a timing at which the backlight starts to emit light.

2. The display apparatus according to claim 1, wherein
the control unit
controls the driving of the base panel in accordance with the frame period including a blanking period at a front end or a rear end of the frame period, and
causes the backlight to emit light during the blanking period.

3. The display apparatus according to claim 2, wherein
a first region and a second region of the backlight are each driven, the first region and the second region having been obtained by dividing the backlight in a vertical direction, and
the control unit
causes the first region to emit light during the blanking period, and
causes the second region to emit light during a predetermined period immediately after the blanking period.

4. The display apparatus according to claim 1, wherein
the backlight is divided into a first number of regions in a direction perpendicular to a direction of a line of the base panel, and
the control unit
drives the base panel in a line sequential manner, and
causes the backlight to sequentially emit light from each of the first number of regions in accordance with the driving in the line sequential manner.

5. The display apparatus according to claim 4, wherein
the retarder panel is divided into a second number of regions in the direction perpendicular to the direction of the line of the base panel, and
the control unit
switches between the first phase and the second phase of each of the second number of regions of the retarder panel obtained by dividing the retarder panel, in accordance with light emission of the first number of regions of the backlight.

6. The display apparatus according to claim 1, wherein
the control unit causes the backlight to emit light at a timing corresponding to a subframe obtained by dividing the frame period.

7. The display apparatus according to claim 1, wherein
the frame period is shorter than a time period in which a state of one line in the base panel is updated.

8. The display apparatus according to claim 1, wherein
the control unit causes the base panel to perform overdrive driving.

9. The display apparatus according to claim 8, wherein
the control unit
controls gradation of the backlight with respect to the image signal such that the gradation is high in a predetermined range on a high gradation side and low in a predetermined range on a low gradation side, and
limits gradation, in the base panel, of the predetermined range on the high gradation side and of the predetermined range on the low gradation side in accordance with the gradation of the backlight with respect to the image signal.

10. The display apparatus according to claim 9, wherein
the backlight is divided into a plurality of regions in a direction of a line of the base panel and in a direction perpendicular to the direction of the line, and
the control unit controls gradation of each of the plurality of regions of the backlight such that the gradation is high in the predetermined range on the high gradation side and low in the predetermined range on the low gradation side, based on the image signal.

11. The display apparatus according to claim 1, wherein
the base panel is a liquid crystal panel using in-plane-switching (IPS) liquid crystal.

12. The display apparatus according to claim 11, wherein
the retarder panel includes a liquid crystal panel using liquid crystal having a higher response speed than liquid crystal used for the base panel.

13. The display apparatus according to claim 12, wherein
the retarder panel includes a combination of a retardation film and the liquid crystal panel.

14. The display apparatus according to claim 12, wherein
the retarder panel includes a combination of two liquid crystal panels each being the liquid crystal panel.

15. The display apparatus according to claim 1, wherein
the backlight uses a light-emitting diode (LED) as a light source.

16. A display method executed by a processor, the display method comprising:
controlling driving of each of
a backlight,
a retarder panel configured to switch a phase of light to pass through the retarder panel between a first phase and a second phase, and
a base panel provided between the backlight and the retarder panel and configured to transmit light from the backlight in response to an image signal and emit the light to the retarder panel, wherein
the controlling includes
causing the backlight to emit light during a time period from a time point at which a time period corresponding to a response speed of the base panel has elapsed from a start timing of a frame period based on the image signal to a writing start timing in a next frame period, and
switching between the first phase and the second phase of the retarder panel in accordance with a timing at which the backlight starts to emit light.
